(19) United States
(12) Patent Application Publication
(10) Pub. No.: US 2020/0014278 A1
(43) Pub. Date: Jan. 9, 2020

(54) ROTOR AND MOTOR

(71) Applicant: Nidec Corporation, Kyoto (JP)

(72) Inventors: Yoshiaki YAMASHITA, Kyoto (JP); Takao ATARASHI, Kyoto (JP)

(21) Appl. No.: 16/487,221

(22) PCT Filed: Mar. 22, 2018
(86) PCT No.: PCT/JP2018/011515

§ 371 Date: Aug. 20, 2019

Related U.S. Application Data
(60) Provisional application No. 62/479,488, filed on Mar. 31, 2017.

(51) Int. Cl. H02K 5/24; H02K 1/27; H02K 1/28; H02K 21/14

(52) U.S. Cl. CPC H02K 5/24; H02K 21/14; H02K 1/28; H02K 1/278

(57) ABSTRACT

A rotor includes a shaft arranged along a central axis extending in a vertical direction, a rotor core fixed on the shaft, magnets provided at an outer side of the rotor core in a radial direction, a rotor cover to accommodate the rotor core and the magnets, and a resin to fix the rotor cover and the magnets to each other. The rotor cover includes a cylindrical portion extending in an axial direction and surrounding outer sides of the rotor core and the magnets in the radial direction, and a bottom plate extending inward in the radial direction from a lower end portion of the cylindrical portion. The resin includes a filler provided at an inner side of the cylindrical portion in the radial direction and filled between the cylindrical portion and the magnets, an anti-separation portion, at least a portion of which is located below the bottom plate, and a connector overlapping the bottom plate in the axial direction. The filler and the anti-separation portion are connected via the connector.

### CROSS REFERENCE TO RELATED APPLICATIONS

This is the U.S. national stage of PCT Application No. PCT/JP2018/011515, filed on Mar. 22, 2018, and priority under 35 U.S.C. § 119(a) and 35 U.S.C. § 365(b) is claimed from US Provisional Application No. 62/479,788, filed Mar. 31, 2017; the entire disclosures of each application are hereby incorporated herein by reference.

### 1. FIELD OF THE INVENTION

The present disclosure relates to a rotor and a motor.

### 2. BACKGROUND

Rotors having a rotor core and a rotor cover covering a permanent magnet are known.

### SUMMARY

In a rotor as described above, for example, it is necessary to suppress a permanent magnet from escaping from a rotor cover in an axial direction.

To address the above problem, example embodiments of the present disclosure provide rotors each capable of appropriately preventing a rotor cover from escaping from a rotor core while stably holding a magnet in the rotor cover, and a motor provided with the rotor.

A rotor according to an example embodiment of the present disclosure includes a shaft arranged along a central axis extending in a vertical direction, a rotor core fixed on the shaft, magnets provided at an outer side of the rotor core in a radial direction, a rotor cover to accommodate the rotor core and the magnets, and a resin to fix the rotor cover and the magnets to each other. The rotor cover includes a cylindrical portion, which extends in an axial direction and surrounds outer sides of the rotor core and the magnets in the radial direction, and a bottom plate, which extends inward in the radial direction from a lower end portion of the cylindrical portion. The resin includes a filler provided at an inner side of the cylindrical portion in the radial direction and filled between the cylindrical portion and the magnets, an anti-separation portion, at least a portion of which is located below the bottom plate, and a connector overlapping the bottom plate in the axial direction. The filler and the anti-separation portion are connected via the connector.

A motor according to an example embodiment of the present disclosure includes the rotor and a stator facing the rotor while being spaced by a gap from the rotor in a radial direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a motor according to an example embodiment of the present disclosure.

FIG. 2 is a cross-sectional view of a rotor according to an example embodiment of the present disclosure.

FIG. 3 is an exploded view of a rotor according to an example embodiment of the present disclosure.

FIG. 4 is a bottom view of a rotor according to an example embodiment of the present disclosure.

FIG. 5 is a cross-sectional view of the rotor, taken along line V-V of FIG. 4.

FIG. 6 is a cross-sectional view of a rotor of a first modified example of an example embodiment of the present disclosure.

FIG. 7 is a cross-sectional view of a rotor of a second modified example of an example embodiment of the present disclosure.

### DETAILED DESCRIPTION

Hereinafter, motors and rotors according to example embodiments of the present disclosure will be described with reference to the accompanying drawings. In the drawings used in the following description, for clarity and convenience of explanation, characteristic parts may be enlarged and a dimensional ratio of each component and the like may be exaggerated.

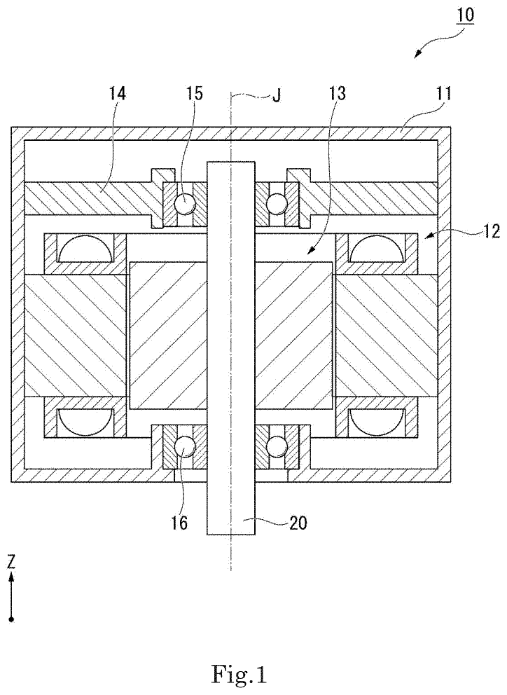

In each of the drawings, a Z-axis is appropriately illustrated. In each of the drawings, a Z-axis direction is a direction parallel to an axial direction of a central axis J illustrated in FIG. 1. In the following description, a positive side (a +Z-side) of the Z-axis direction will be referred to as an “upper side”, and a negative side (a -Z-side) of the Z-axis direction will be referred to as a “lower side”. Unless stated specifically, a direction parallel to the central axis J (the Z-axis direction) will be referred to simply as an “axial direction” or a “vertical direction”. A radial direction with respect to the central axis J as a center thereof will be referred to simply as a “radial direction”. A circumferential direction with respect to the central axis J as a center thereof, i.e., a direction along a circumference of the central axis J, will be referred to simply as a “circumferential direction”. In the following description, a “plan view” means a state viewed in the axial direction. The terms “upper side” and “lower side” refer to directions used merely for the purpose of explanation and thus an actual positional relationship therebetween or directions thereof are not limited thereby.

FIG. 1 is a cross-sectional view of a motor 10 according to a present example embodiment.

The motor 10 of the present example embodiment includes a housing 11, a stator 12, a rotor 13 provided with a shaft 20 arranged along a central axis J extending in a vertical direction, a bearing holder 14, and bearings 15 and 16. The stator 12 is located at an outer side of the rotor 13 to face the rotor 13 in the radial direction while having a gap with the rotor 13. The shaft 20 is rotatably supported by the bearings 15 and 16. The shaft 20 has a cylindrical shape extending in the axial direction.

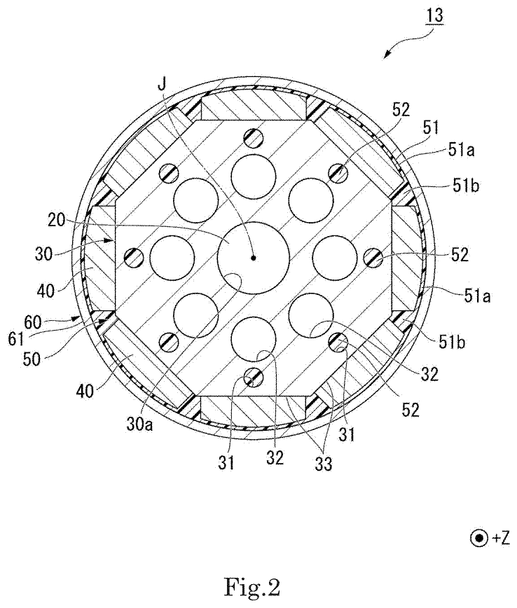

FIG. 2 is a cross-sectional view taken along a cross section of the rotor 13 perpendicular to the axial direction.

The rotor 13 includes the shaft 20, a rotor core 30, a plurality of magnets 40, a rotor cover 60, and a resin part 50.

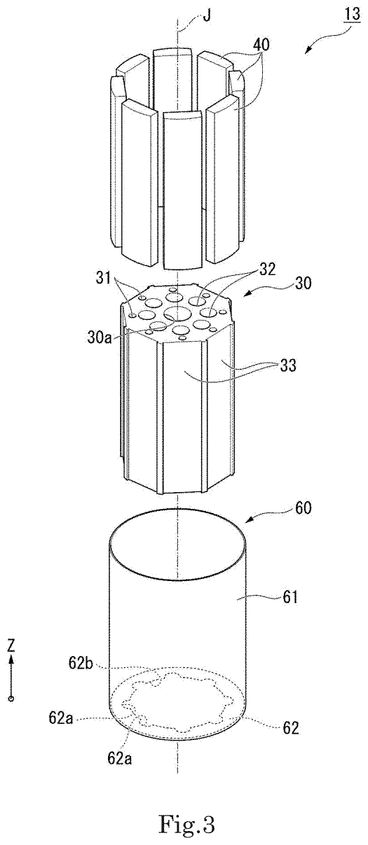

FIG. 3 is an exploded view of the rotor 13. In FIG. 3, the shaft 20 and the resin part 50 are omitted.

The rotor core 30 has a columnar shape extending in the axial direction. Although not shown, the rotor core 30 is configured by stacking a plurality of electrical steel sheets in the axial direction. The rotor core 30 is a regular octagonal prism with the central axis J as a center thereof. The rotor core 30 has a plurality of magnet support surfaces 33 (eight support surfaces 33 in the present example embodiment). The magnet support surfaces 33 are arranged in a circumferential direction of an outer circumferential surface of the rotor core 30 facing an outer side of the rotor core 30 in the radial direction. The magnet support surfaces 33 extend in the axial direction. The magnet support surfaces 33 are flat surfaces perpendicular to the radial direction.

The rotor core 30 is provided with one fixing hole 30a, a plurality of first core through holes (core through holes) 31, and a plurality of second core through holes 32. The fixing hole 30a, the first core through holes 31, and the second core through holes 32 pass through the rotor core 30 in the axial direction.

As illustrated in FIG. 2, the fixing hole 30a is located at a center of the rotor core 30 when viewed in the axial direction. The fixing hole 30a has a round shape with the central axis J as a center thereof when viewed in the axial direction. The shaft 20 passes through the fixing hole 30a. An inner circumferential surface of the fixing hole 30a is fixed on an outer circumferential surface of the shaft 20. Accordingly, the rotor core 30 is fixed on the shaft 20.

The first core through holes 31 are arranged in parallel to be spaced the same distance from each other in a circumferential direction. In the present example embodiment, the rotor core 30 is provided with eight first core through holes 31. The first core through holes 31 each have a round shape when viewed in the axial direction. Each of the first core through holes 31 is located in inner surfaces of the magnet support surfaces 33 in the radial direction. As will be described below, the insides of the rear ends of the first core through holes 31 are filled with a portion of the resin parts 50 (through-hole filling parts 52).

The second core through holes 32 are arranged in parallel to be spaced the same distance from each other in a circumferential direction. In the present example embodiment, the rotor core 30 is provided with eight second core through holes 32. The second core through holes 32 each have a round shape when viewed in the axial direction. In the present example embodiment, the diameters of the second core through holes 32 are greater than those of the first core through holes 31. Each of the first core through holes 31 is located inside one of the first core through holes 31 in the radial direction. In the present example embodiment, the numbers of the first core through holes 31, the second core through holes 32 and the magnet support surfaces 33 of the rotor core 30 are the same.

As described above, the rotor core 30 is configured by stacking a plurality of electrical steel sheets in the axial direction. The second core through holes 32 are used to align the electrical steel sheets with each other when the electrical steel sheets are stacked.

The weight of the rotor core 30 may be reduced by forming the second core through holes 32 therein.

As illustrated in FIG. 3, the magnets 40 are located on the outer side of the rotor core 30 in the radial direction. The magnets 40 have a roughly square pillar shape which is flat in the radial direction and extends in the axial direction. The magnets 40 are arranged spaced apart from each other in the circumferential direction. In more detail, the magnets 40 are arranged along the outer side of the rotor core 30 in the circumferential direction to be spaced the same distance from each other.

Each of the magnets 40 is supported by an inner side of one of the magnet support surfaces 33 in the radial direction. The inner sides of the magnets 40 in the radial direction are flat surfaces perpendicular to the radial direction and are in contact with the magnet support surfaces 33. Outer sides of the magnets in the radial direction are curved surfaces curved in the circumferential direction and along an inner side of a cylindrical part 61 of the rotor cover 60, which will be described below, in the radial direction. The center of curvature of the outer side of each of the magnets 40 coincides with the central axis J. Magnetic characteristics of the motor 10 may be improved because the outer sides of the magnets 40 in the radial direction are curved surfaces.

In the present example embodiment, the outer side of the magnet 40 in the radial direction and an inner circumferential surface of the magnet 40 are opposite each other while having a gap therebetween in the radial direction. The outer side of the magnet 40 in the radial direction may be in contact with an inner side of the rotor cover 60 in the radial direction.

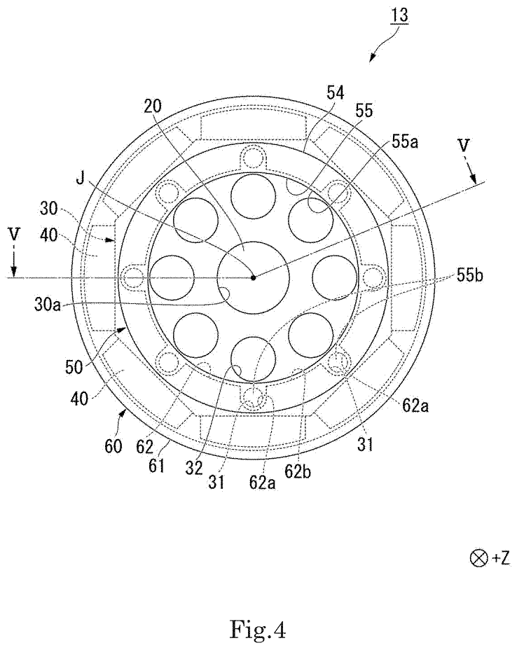

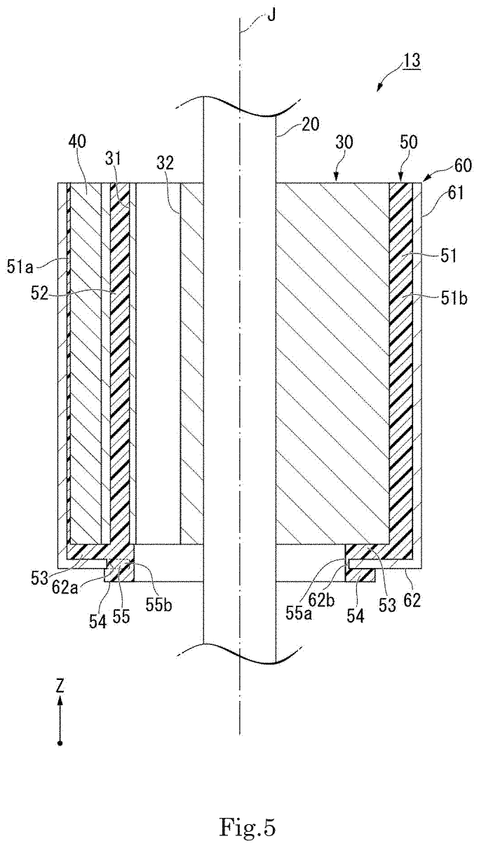

FIG. 4 is a bottom view of the rotor 13. FIG. 5 is a cross-sectional view of the rotor 13, taken along line V-V of FIG. 4.

As illustrated in FIG. 5, the dimension of the magnet 40 in the axial direction is the same as that of the rotor core 30 in the axial direction. An upper surface of the magnet 40 and an upper surface of the rotor core 30 are located on the same plane perpendicular to the axial direction. A lower surface of the magnet 40 and a lower surface of the rotor core 30 are located on the same plane perpendicular to, for example, the axial direction.

As illustrated in FIG. 3, the rotor cover 60 accommodates the rotor core 30 and the magnets 40. The rotor cover 60 includes the cylindrical part 61 and a bottom plate part 62. The cylindrical part 61 has a tubular shape extending in the axial direction. More specifically, the cylindrical part 61 has a cylindrical shape with the central axis J as a center thereof. Opposite sides of the cylindrical part 61 in the axial direction are open.

As illustrated in FIG. 2, the cylindrical part 61 surrounds the outer sides of the rotor core 30 and the magnets 40 in the radial direction. As illustrated in FIG. 5, an upper end portion of the cylindrical part 61 substantially coincides with upper end portions of the magnets 40 and the rotor core 30. A lower end portion of the cylindrical part 61 is lower than the upper end portions of the magnets 40 and a lower end portion of the rotor core 30.

As illustrated in FIG. 5, the bottom plate part 62 extends from the lower end portion of the cylindrical part 61 toward the inner side thereof in the radial direction. The bottom plate part 62 has an annular plate shape extending in the circumferential direction. The bottom plate part 62 is located below the rotor core 30 and the magnets 40. An upper surface of the bottom plate part 62 vertically faces the lower surface of the rotor core 30 and lower surfaces of the magnets 40.

The bottom plate part 62 has an inner circumferential edge 62b at an inner end thereof in the radial direction. The shaft 20 passes through an inner side of the inner circumferential edge 62b. As illustrated in FIG. 4, the inner circumferential edge 62b of the bottom plate part 62 is provided with a plurality of notches 62a extending outward in the radial direction.

The notches 62a overlap the first core through holes 31 when viewed in the axial direction. In the present example embodiment, when viewed in the axial direction, all of the first core through holes 31 are located inside inner sides of the notches 62a. However, at least part of the notches 62a may overlap the first core through holes 31 when viewed in the axial direction.

In the present example embodiment, eight notches 62a are provided on the inner circumferential edge 62b of the bottom plate part 62. The number of the notches 62a is the same as that of the first core through holes 31. The eight notches 62a are arranged along the inner circumferential edge 62b in the circumferential direction to be spaced the same distance from each other.

As illustrated in FIG. 5, the resin part 50 fixes the rotor cover 60 and the magnets 40 to each other. Furthermore, the resin part 50 fixes the rotor cover 60 and the rotor core 30 to each other. That is, the resin part 50 holds the rotor cover 60, the rotor core 30, and the magnets 40 while connecting them to each other. At least a portion of the resin part 50 is located at an inner side of the cylindrical part 61 of the rotor cover 60 in the radial direction.

The resin part 50 is integrally formed with the rotor core 30, the magnets 40, and the rotor cover 60 by performing insert molding by pouring resin into a mold into which the rotor core 30, the magnets 40, and the rotor cover 60 are inserted. The resin part 50 is bonded onto surfaces of the rotor core 30, the magnets 40 and the rotor cover 60 by being insert-molded with them.

The resin part 50 includes a filling part 51, the through-hole filling parts 52, a lid part (first lid part) 53, an anti-separation part 54, and a connecting part 55. The filling part 51, the through-hole filling parts 52, the lid part 53, the anti-separation part 54, and the connecting part 55 are connected to one another.

The filling part 51 is located at the inner side of the cylindrical part 61 in the radial direction. The filling part 51 is filled between the cylindrical part 61 and the magnets 40. The filling part 51 is filled between the cylindrical part 61 and the magnets 40 in the radial direction. The filling part 51 extends along outer circumferential surfaces of the magnets 40 in the axial direction. The filling part 51 is in contact with the outer circumferential surfaces of the magnets 40 and a portion of the outer circumferential surface of the rotor core 30.

As illustrated in FIG. 2, the filling part 51 includes first filling regions 51a and second filling regions 51b. The first filling regions 51a and the second filling regions 51b are alternately arranged in the circumferential direction. The first filling regions 51a are located between the outer circumferential surfaces of the magnets 40 and the inner circumferential surface of the cylindrical part 61 of the rotor cover 60 in the radial direction. The second filling regions 51b are located between the magnets 40 in the circumferential direction.

The first filling region 51a may not be provided when the outer circumferential surfaces of the magnets 40 and the inner circumferential surface of the cylindrical part 61 are in contact with each other.

According to the present example embodiment, at least a portion of the filling part 51 (the second filling region 51b in the present example embodiment) is located between the magnets 40 arranged in the circumferential direction. Thus, the filling part 51 may hold the magnets 40 and align the magnet 40 with the rotor core 30 and the rotor cover 60.

The first core through holes 31 are filled with the through-hole filling parts 52. The through-hole filling parts 52 extend along the inner circumferential surfaces of the first core through holes 31 in the axial direction. The through-hole filling parts 52 have a cylindrical shape extending in the axial direction. The through-hole filling parts 52 are in contact with the inner circumferential surfaces of the first core through holes 31.

In the present example embodiment, the resin part 50 includes the through-hole filling parts 52. Each of the through-hole filling parts 52 passes through one of the first core through holes 31. Thus, the resin part 50 and the rotor core 30 may be more firmly combined with each other. In addition, according to the present example embodiment, the through-hole filling parts 52 are filled in the first core through holes 31 and thus the movement of the resin part 50 relative to the rotor core 30 in the circumferential direction may be restricted.

As illustrated in FIG. 5, the lid part 53 is located below the rotor core 30. The lid part 53 extends annularly around the central axis J. The lid part 53 is connected to the filling part 51 and the through-hole filling parts 52. In other words, the filling part 51 and the through-hole filling parts 52 extend upward from the lid part 53.

The lid part 53 is located between the lower surface of the rotor core 30, lower surfaces of the magnets 40, and the upper surface of the bottom plate part 62. That is, the lid part 53 is located between the rotor core 30, the magnets 40 and the bottom plate part 62. The lid part 53 is in contact with the lower surface of the rotor core 30 and the lower surfaces of the magnets 40. The lid part 53 is also in contact with the upper surface of the bottom plate part 62. A downward movement of the magnets 40 relative to the rotor core 30 may be restricted by the lid part 53.

An outer edge of the lid part 53 in the radial direction is in contact with the inner circumferential surface of the cylindrical part 61. An inner edge of the lid part 53 in the radial direction is located more radially inward than the inner circumferential edge 62b of the bottom plate part 62. The inner edge of the lid part 53 in the radial direction is located more radially outward than the second core through holes 32. The lid part 53 extends inward in the radial direction from the inner circumferential surface of the cylindrical part 61 to the front of the second core through holes 32 beyond the inner circumferential edge 62b of the bottom plate part 62.

The anti-separation part 54 extends annularly around the central axis J. The anti-separation part 54 is located below the bottom plate part 62. The anti-separation part 54 is in contact with the lower surface of the bottom plate part 62.

As illustrated in FIG. 4, an outer edge of the anti-separation part 54 in the radial direction is located further outward than outer edges of the notches 62a of the bottom plate part 62 in the radial direction. An inner edge of the anti-separation part 54 in the radial direction coincides with the inner edge of the lid 53 in the radial direction when viewed in the axial direction.

As illustrated in FIG. 5, the connecting part 55 connects the lid part 53 and the anti-separation part 54. The connecting part 55 is located between the lid part 53 and the anti-separation part 54 with respect to the inner side of the bottom plate part 62 in the radial direction. The connecting part 55 overlaps the bottom plate part 62 in the axial direction.

The connecting part 55 includes a first connection region 55a located at the inner side of the inner circumferential edge 62b of the bottom plate part 62 in the radial direction, and a plurality of second connection regions 55b located at inner sides of the notches 62a. That is, at least a portion of the connecting part 55 (the second connection regions 55b in the present example embodiment) is located at the inner sides of the notches 62a.

The first connection region 55a extends annularly around the central axis J. The first connection region 55a is in contact with the inner circumferential edge 62b of the bottom plate part 62. An inner edge of the first connection region 55a in the radial direction coincides with the inner edge of the lid part 53 in the radial direction and the inner edge of the anti-separation part 54 in the radial direction when viewed in the axial direction.

The second connection regions 55b extend radially outward from the first connection region 55a. The second connection regions 55b are in contact with the inner sides of the notches 62a. The second connection regions 55b overlap the through-hole filling parts 52 when viewed in the axial direction.

According to the present example embodiment, the resin part 50 includes the filling part 51 filled between the cylindrical part 61 and the magnets 40, and the anti-separation part 54 located below the bottom plate part 62. The filling part 51 and the anti-separation part 54 are connected via the lid part 53 and the connecting part 55. Therefore, the bottom plate part 62 is sandwiched between the filling part 51 and the anti-separation part 54 in the axial direction. According to the present example embodiment, the movement of the bottom plate part 62 relative to the resin part 50 in the axial direction may be limited. As a result, in the rotor 13, the separation of the rotor cover 60 from the resin part 50 in the axial direction may be suppressed.

According to the present example embodiment, the bottom plate part 62 is fitted to the lid part 53 and the anti-separation part 54 in the axial direction. The lid part 53 and the anti-separation part 54 are connected to each other via the first connection region 55a and the second connection regions 55b of the connecting part 55. That is, a portion of the bottom plate part 62 is embedded in the resin part 50. Accordingly, a contact area between the resin part 50 and the bottom plate part 62 is increased, thereby effectively suppressing the rotation of the resin part 50 with respect to the rotor 13.

According to the present example embodiment, the second connection regions 55b of the connecting part 55 are located at the inner sides of the notches 62a. The second connection regions 55b are sandwiched between the inner sides of the notches 62a in the circumferential direction. Therefore, the movement of the rotor cover 60 with respect to the resin part 50 in the circumferential direction may be restricted by the second connection regions 55b. A high inertial force is applied to the rotor cover 60 when the number of rotations of the rotor 13 is sharply increased or when the rotation of the rotor 13 is suddenly stopped. According to the present example embodiment, even when the high inertia force is applied to the rotor cover 60, the second connection regions 55b may suppress the rotation of the rotor cover 60 relative to the resin part 50.

According to the present example embodiment, the notches 62a are arranged in parallel in the circumferential direction. In addition, each of the second connection regions 55b is located at the inner side of one of the notches 62a. Thus, the second connection regions 55b may suppress the rotation of the rotor cover 60 at a plurality of locations on the bottom plate part 62 in the circumferential direction in a well-balanced manner.

According to the present example embodiment, the notches 62a overlap the first core through holes 31 when viewed in the axial direction. Thus, when the resin part 50 is insert-molded, the resin part 50 may smoothly flow from the notches 62a toward the first core through holes 31. Accordingly, the inside of the first core through holes 31 may be filled with the resin part 50 without having gaps therein, and the resin part 50 and the rotor core 30 may be more firmly combined with each other.

According to the present example embodiment, the resin part 50 is formed by insert molding such that the rotor cover 60, the magnets 40 and the rotor core 30 are embedded therein. Thus, it is easy to form the resin part 50 in contact with the magnets regardless of a dimensional error of the magnets 40. Accordingly, gaps may be suppressed from occurring between the resin part 50 and the magnets 40, and the magnets 40 may be stably held in the rotor cover 60.

According to the present example embodiment, the resin part 50 suppresses the rotation of the rotor cover 60 relative to the rotor core 30 while stably holding the magnets 40 in the rotor cover 60. Thus, the rotor 13 which suppresses the rotation of the rotor cover 60 relative to the rotor core 30 may be achieved. It is possible to reduce vibration generated by the motor 10 by suppressing the movement of the parts of the rotor 13 relative to each other. Therefore, the motor 10 may be driven efficiently due to the reduction of noise generated by the motor 10.

Because the resin part 50 has both a function of holding the magnets 40 and a function of preventing the rotation of the rotor cover 60, the number of processes of assembling the rotor 13 may be easily reduced. Specifically, the resin part 50 is formed by insert molding as described above and thus both the stable holding of the magnets 40 and the appropriate preventing of the rotation of the rotor cover 60 may be achieved. Thus, according to the present example embodiment, the assembly process of the rotor 13 may be facilitated. Moreover, according to the present example embodiment, it is not necessary to use an adhesive to hold the magnets 40, and a process and equipment for curing the adhesive are not needed.

In the present example embodiment, the rotor cover 60 includes the bottom plate part 62 on only one side (the lower side) of the cylindrical part 61 in the axial direction. Alternatively, the rotor cover 60 may have bottom plate parts on both sides of the cylindrical part 61 in the axial direction. In this case, one of the bottom plate parts is formed, for example, by a caulking process.

In the present example embodiment, the resin part 50 has the lid part only on one side (the lower side) of the rotor core 30 in the axial direction. Alternatively, the resin part 50 may include lid parts on both sides of the rotor core 30 in the axial direction. Similarly, an anti-separation part and a connecting part may be provided on both sides of the rotor core 30.

### FIRST MODIFIED EXAMPLE

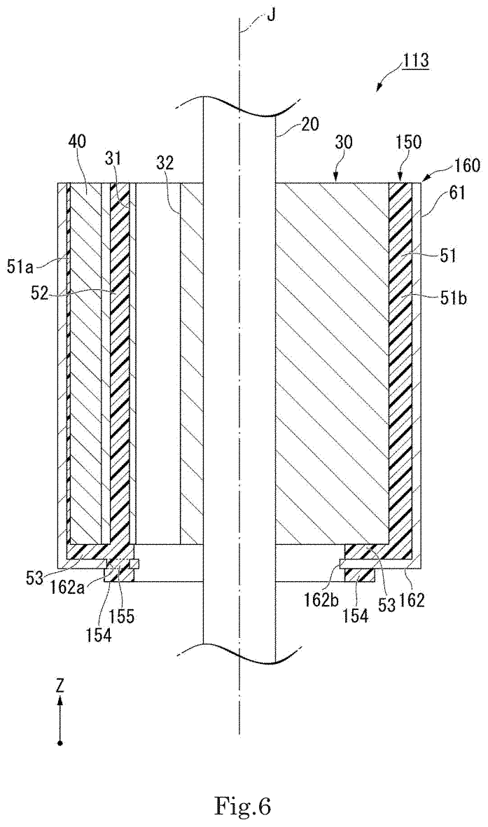

FIG. 6 is a cross-sectional view of a rotor 113 of a first modified example of the above-described example embodiment. FIG. 6 corresponds to FIG. 4 illustrating the above-described example embodiment. The rotor 113 of the first modified example will be described below on the basis of FIG. 6. The rotor 113 of the present modified example is mainly different from the above-described example embodiment in that a plurality of cover through holes 162a are provided instead of the notches 62a.

Components that are of the same form as in the above-described example embodiment are assigned the same reference numerals and are not described here again.

Similar to the above-described example embodiment, the rotor 113 includes a shaft 20, a rotor core 30, a plurality of magnets 40, a rotor cover 160, and a resin part 150. The rotor core 30 is provided with first core through holes 31 and second core through holes 32.

The rotor cover 160 includes a cylindrical part 61 and a bottom plate part 162. The bottom plate part 162 extends radially inward from a lower end portion of the cylindrical part 61. The bottom plate part 162 has an annular plate shape extending in a circumferential direction. The bottom plate part 162 is located below the rotor core 30 and the magnets 40. The bottom plate part 162 includes an inner circumferential edge 162b which is an inner edge thereof in a radial direction.

The bottom plate part 162 is provided with the cover through holes 162a passing therethrough in an axial direction. The cover through holes 162a each have a round shape when viewed in the axial direction.

The cover through holes 162a overlap the first core through holes 31 when viewed in the axial direction. In the present modified example, when viewed in the axial direction, the first core through holes 31 are located inside an inner side of the cover through holes 162a. Alternatively, when viewed in the axial direction, at least part of the cover through holes 162a may overlap the first core through holes 31.

In the present modified example, eight cover through holes 162a are formed in the bottom plate part 162. That is, the number of the cover through holes 162a is the same as that of the first core through holes 31. The eight cover through holes 162a are arranged along the bottom plate part 162 in the circumferential direction to be spaced the same distance from each other.

The resin part 150 includes a filling part 51, a plurality of through-hole filling parts 52, a lid part 53, an anti-separation part 154, and a connecting part 155. Similar to the above-described example embodiment, the lid part 53 is located between the rotor core 30, the magnets 40, and the bottom plate part 162.

The anti-separation part 154 extends annularly around a central axis J. The anti-separation part 154 is located below the bottom plate part 162. The anti-separation part 154 is in contact with a lower surface of the bottom plate part 162.

The connecting part 155 overlaps the bottom plate part 162 in the axial direction. The connecting part 155 connects the lid part 53 and the anti-separation part 154. The connecting part 155 is located inside the cover through holes 162a. That is, at least part of the connecting part 155 (an entirety of the connecting part 155 in the present modified example) is located inside the cover through holes 162a. The connecting part 155 is in contact with inner sides of the cover through holes 162a. The connecting part 155 overlaps the through-hole filling part 52 when viewed in the axial direction.

In the present modified example, the lid part 53 and the anti-separation part 154 are fitted to the bottom plate part 162 in the axial direction. The lid part 53 and the anti-separation part 154 are connected through the connecting part 155. That is, part of the bottom plate part 162 is embedded in the resin part 150. Thus, the movement of the bottom plate part 162 relative to the resin part 150 in the axial direction may be restricted by the resin part 150. Accordingly, in the rotor 113, the separation of the rotor cover 160 from the resin part 150 in the axial direction may be suppressed.

In the present modified example, the connecting part 155 is located inside the cover through holes 162a. The connecting part 155 is fitted between the inner sides of the cover through holes 162a in the circumferential direction. Thus, the movement of the rotor cover 160 with respect to the resin part 150 in the circumferential direction the connecting part 155 is restricted by the connecting part 155. In the present modified example, even when a high inertia force is applied to the rotor cover 160, the connecting part 155 may suppress the rotation of the rotor cover 160 relative to the resin part 150.

In the present modified example, the cover through holes 162a are arranged in parallel in the circumferential direction. Each of a plurality of connecting parts 155 is arranged in a corresponding one of the cover through holes 162a. Thus, the connecting parts 155 may suppress the rotation of the bottom plate part 162 at a plurality of positions in the circumferential direction in a well-balanced manner.

In the present modified example, the cover through holes 162a overlap the first core through holes 31 when viewed in the axial direction. Thus, when the resin part 150 is insert-molded, the resin part 150 may smoothly flow from the cover through holes 162a toward the first core through holes 31. Accordingly, the inside of the first core through holes 31 may be filled with the resin part 150 without having gaps therein, and the resin part 150 and the rotor core 30 may be more firmly combined with each other.

### SECOND MODIFIED EXAMPLE

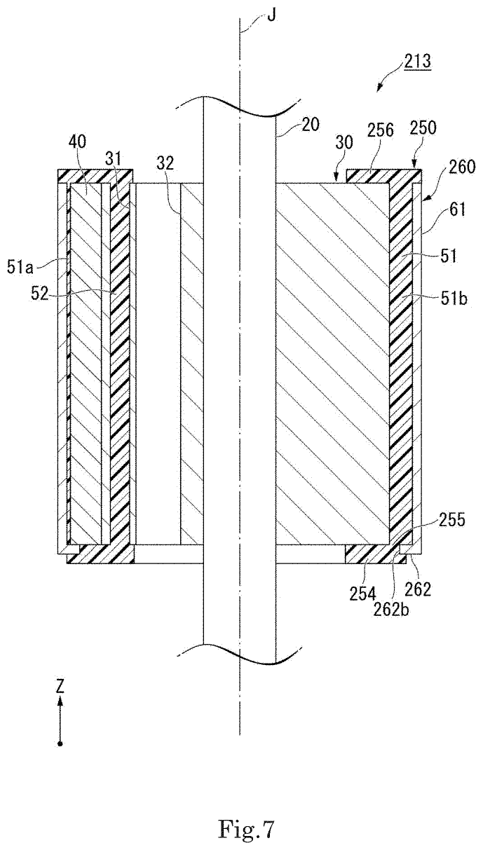

FIG. 7 is a cross-sectional view of a rotor 213 of a second modified example of the above-described example embodiment. FIG. 7 corresponds to FIG. 4 in illustrating the above-described example embodiment. The rotor 213 of the second modified example will be described below on the basis of FIG. 7. The rotor 213 of the present modified example is mainly different from the above-described example embodiment in that a resin part 250 includes a lid part 256 and does not include a first lid part.

Components that are of the same form as in the above-described example embodiment are assigned the same reference numerals and are not described here again.

Similar to the above-described example embodiment, the rotor 213 includes a shaft 20, a rotor core 30, a plurality of magnets 40, a rotor cover 260, and the resin part 250. The rotor core 30 is provided with first core through holes 31 and second core through holes 32.

The rotor cover 260 includes a cylindrical part 61 and a bottom plate part 262. The bottom plate part 262 extends inward in a radial direction from a lower end portion of the cylindrical part 61. The bottom plate part 262 has an annular plate shape extending in a circumferential direction. The bottom plate part 262 is located below the rotor core 30 and the magnets 40. The bottom plate part 262 includes an inner circumferential edge 262b on an inner edge thereof in the radial direction. In the present modified example, an upper surface of the bottom plate part 262 is in contact with the rotor core 30.

The resin part 250 includes a filling part 51, a plurality of through-hole filling parts 52, the lid part (second lid part) 256, an anti-separation part 254, and a connecting part 255.

The anti-separation part 254 extends annularly around a central axis J. At least a portion of the anti-separation part 254 is located below the bottom plate part 262. Thus, a portion of the anti-separation part 254 is in contact with a lower surface of the bottom plate part 262. Furthermore, a portion of an upper surface of the anti-separation part 254 is in contact with a lower surface of the rotor core 30.

The connecting part 255 overlaps the bottom plate part 262 in the axial direction. The connecting part 255 may connect the anti-separation part 254 and the filling part 51. That is, the filling part 51 and the anti-separation part 254 are connected through the connecting part 255. In the present modified example, the bottom plate part 262 is fitted to the filling part 51 and the anti-separation part 254 in the axial direction. Thus, the resin part 250 restricts the movement of the bottom plate part 262 relative thereto in the axial direction. In the present modified example, the movement of the bottom plate part 262 relative to the resin part 250 in the axial direction may be limited. Accordingly, in the rotor 213, the separation of the rotor cover 260 from the resin part 250 in the axial direction may be suppressed.

In the present modified example, the lid part 256 is located on the rotor core 30. A lower surface of the lid part 256 is in contact with an upper surface of the rotor core 30. The lid part 256 is connected to the filling part 51. As described above, the lower surface of the rotor core 30 is in contact with the anti-separation part 254. Thus, the rotor core 30 is fitted to the through lid part 256 and the anti-separation part 254 in the axial direction. The lid part 256 and the anti-separation part 254 are connected via the filling part 51. Accordingly, the resin part 250 may be suppressed from being separated from the rotor core 30.

According to an example embodiment of the present disclosure, there are provided a rotor capable of appropriately suppressing a rotor cover from escaping from a rotor core while stably holding a magnet in the rotor cover, and a motor provided with the rotor.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11. A rotor comprising:
a shaft arranged along a central axis extending in a vertical direction;
a rotor core fixed on the shaft;
magnets provided at an outer side of the rotor core in a radial direction;
a rotor cover to accommodate the rotor core and the magnets; and
a resin to fix the rotor cover and the magnets to each other; wherein the rotor cover includes:
a cylindrical portion extending in an axial direction and surrounding outer sides of the rotor core and the magnets in the radial direction; and
a bottom plate extending inward in the radial direction from a lower end portion of the cylindrical portion;
the resin includes:
a filler provided at an inner side of the cylindrical portion in the radial direction and filled between the cylindrical portion and the magnets;
an anti-separation portion, at least a portion of which is located below the bottom plate; and
a connector overlapping the bottom plate in the axial direction; and
the filler and the anti-separation portion are connected via the connector.

12. The rotor of claim 11, wherein
a core through hole is provided in the rotor core to pass therethrough in the axial direction; and
the resin includes a through-hole filler to fill in the core through hole.

13. The rotor of claim 12, wherein
a notch is provided on an inner circumferential edge of the bottom plate, the notch extending outward in the radial direction;
the notch overlaps the core through hole when viewed in the axial direction; and
at least a portion of the connector is located at an inner side of the notch.

14. The rotor of claim 13, wherein
a plurality of notches are provided in the bottom plate;
the plurality of notches are arranged in parallel or substantially in parallel around the bottom plate in a circumferential direction.

15. The rotor of claim 12, wherein
a cover through hole is provided in the bottom plate to pass therethrough in the axial direction;
the cover through hole overlaps the core through hole when viewed in the axial direction; and
at least a portion of the connector is located inside the cover through hole.

16. The rotor of claim 15, wherein
a plurality of cover through holes are provided in the bottom plate;
the plurality of cover through holes are arranged in parallel or substantially in parallel around the bottom plate in a circumferential direction.

17. The rotor of claim 11, wherein at least a portion of the filler is located between the magnets arranged in the circumferential direction.

18. The rotor of claim 11, wherein
the resin includes a lid portion located between the rotor core and the bottom plate in the axial direction;
the bottom plate is fitted to the lid portion and the anti-separation portion in the axial direction.

19. The rotor of claim 11, wherein
the resin includes a lid portion located above the rotor core;
the second lid portion is connected to the filler.

20. A motor comprising:
the rotor of claim 11; and
a stator provided to face the rotor and spaced by a gap from the rotor in a radial direction.
